(19) United States
(12) Patent Application Publication
(10) Pub. No.: US 2026/0217935 A1
(43) Pub. Date: Jul. 30, 2026

(54) SOLVATIZATION OF LINEAR POLYURETHANE-MATERIALS VIA CAPROLACTAM/ALCOHOLE MIXTURES

(71) Applicant: BASF SE, Ludwigshafen am Rhein (DE)

(72) Inventors: Markus SCHUETTE, Lemfoerde (DE); Heinz-Dieter LUTTER, Lemfoerde (DE); Lukas Friedrich Berto WILM, Lemfoerde (DE); Goekhan BAKIS, Lemfoerde (DE); Stefan BOKERN, Lemfoerde (DE); Elmar POESELT, Lemfoerde (DE); Manuela FAEHMEL, Lemfoerde (DE); Alina WILDEIS, Lemfoerde (DE)

(73) Assignee: BASF SE, Ludwigshafen am Rhein (DE)

(21) Appl. No.: 19/144,546

(22) PCT Filed: Dec. 29, 2023
(86) PCT No.: PCT/EP2023/087997

§ 371 Date: Jun. 30, 2025

(30) Foreign Application Priority Data
Dec. 30, 2022 (EP) 22217313.0

(51) Int. Cl. C08J 11/08; C08G 18/20; C08G 18/24; C08G 18/48; C08G 18/72; C08G 18/76; C08G 18/79

(52) U.S. Cl. CPC C08J 11/08; C08G 18/2063; C08G 18/244; C08G 18/4841; C08G 18/725; C08G 18/7621; C08G 18/7671; C08G 18/797; C08G 2110/0008; C08G 2110/0083; C08J 2375/04

(57) ABSTRACT

The present invention relates to a process for recovering an elastic polyurethane from a composition comprising an elastic polyurethane foam comprising the steps of providing a composition comprising a polyurethane foam; heating the composition comprising a polyurethane foam to a temperature in the range of from 140° C. to 220° C., and bringing the composition comprising the polyurethane foam into contact with a solvent mixture (SM) comprising at least one alcohol and at least one compound (A1) selected from the group consisting of cyclic amides at a temperature below the boiling point of the alcohol to obtain a solution (S1) which is enriched in dissolved polyurethane. The present invention also relates to the polyurethane obtained or obtainable according to said process as well as the use of the polyurethane according to the present invention for the preparation of a shaped article.

The present invention relates to a process for recovering an elastic polyurethane from a composition comprising an elastic polyurethane foam comprising the steps of providing a composition comprising a polyurethane foam; heating the composition comprising a polyurethane foam to a temperature in the range of from 140° C. to 220° C., and bringing the composition comprising the polyurethane foam into contact with a solvent mixture (SM) comprising at least one alcohol and at least one compound (A1) selected from the group consisting of cyclic amides at a temperature below the boiling point of the alcohol to obtain a solution (S1) which is enriched in dissolved polyurethane. The present invention also relates to the polyurethane obtained or obtainable according to said process as well as the use of the polyurethane according to the present invention for the preparation of a shaped article.

Hand-in-hand with the vigorous growth of the polyurethane production industry, there has been a concomitant increase in the problem of removing and re-using polyurethane waste or reject goods. There is therefore considerable interest both on ecological and on economic grounds for industrially utilizing the ever-increasing quantities of polyurethane waste.

Different strategies have been suggested in the literature. U.S. Pat. No. 4,115,298A discloses process for splitting up polyurethane waste into activated polyhydroxyl compounds which may be reused for the production of polyurethane plastics. The process broadly comprises reacting the polyurethane waste with lactams or equilibrium associates of lactams and active hydrogen containing compounds at elevated temperatures.

Also U.S. Pat. No. 4,160,749A is directed to a process for dissociating cellular and non-cellular polyurethane resins into re-usable starting products for the isocyanate polyaddition process, wherein the polyurethane is reacted with associates of lactams and adduct-formers having at least two Zerewitinoff-active hydrogen atoms at elevated temperature.

The depolymerization is one way to recover waste products. However, it would be preferable to reuse the polyurethane without depolymerization thus reducing the costs of the process. Therefore, it was an object of the present invention to provide a process for separating an elastic polyurethane from other additives which may be present in a waste composition.

This object is solved by a process for recovering an elastic polyurethane from a composition comprising an elastic polyurethane foam comprising the steps of
(a) providing a composition comprising a polyurethane foam;
(b) heating the composition comprising a polyurethane foam to a temperature in the range of from 140° C. to 220° C.;
(c) bringing the composition comprising the polyurethane foam into contact with a solvent mixture (SM) comprising at least one alcohol and at least one compound (A1) selected from the group consisting of cyclic amides at a temperature below the boiling point of the alcohol to obtain a solution (S1) which is enriched in dissolved polyurethane.

It has surprisingly been found that bigger samples of block foams can not be completely dissolved in the solvent mixture comprising caprolactam and methanol as described by Wagner et al. and in particular the core is not dissolved (K. Wagner, Angew. Makromol. Chem. 1974, 37, 59-88). Surprisingly, it is possible to fully dissolve an elastic polyurethane in the solvent mixture (SM) comprising a lactam or cis amide and an alcohol using the process according to the present invention. It has been found that elastic foams from samples, even large ones, become completely soluble after being subjected to a tempering step.

The tempering of block foams after production is an established technique used to bring material that has not yet fully reacted in the outer areas to a complete reaction and formation of crosslinking which is already present in the core area due to the higher local reaction temperatures present during the reaction. It was surprisingly found that the tempering step results in improved solubility.

It has been found that the elastic polyurethane can be dissolved without degradation of the polymeric structure. This allows to recover the polyurethane from a composition without depolymerizing the polyurethane. Thus, the polyurethane can easily be reused.

The process according to the present invention comprises steps (a), (b), and (c). The process may also comprise further steps. According to step (a), a composition comprising a polyurethane foam is provided. According to step (b), the composition comprising a polyurethane foam is heated to a temperature in the range of from 140° C. to 220° C. According to step (c), the heat treated composition comprising the polyurethane foam is brought into contact with a solvent mixture (SM) comprising at least one alcohol and at least one compound (A1) selected from the group consisting of cyclic amides to obtain a solution (S1) which is enriched in dissolved polyurethane.

The composition comprising a polyurethane foam may comprise further additives or solid particles which are not soluble in the solvent mixture used. The composition may for example comprise additives which are frequently used in polyurethane foams such as fillers, such as chalk, flame retardants, such as melamine or pigments.

The properties of suitable compositions comprising a polyurethane foam which may be used in the process of the present invention may vary in broad ranges. According to the present invention, any any polyurethane foam comprising an elastic polyurethane may be used. For example, waste foams may be used as a starting material in step (a) of the process of the present invention.

Suitable foams may for example be flexible polyurethane foams. According to a further embodiment, the present invention also is directed to the process as disclosed above, wherein the elastic polyurethane foam is a flexible polyurethane foam.

The polyurethane foams used in the present invention may be obtained from items produced from polyurethane foams at a time after use for the purpose for which they were manufactured or polyurethane foam waste from production processes. Before subjecting to step (a) of the process of the present invention, the items may be subjected to mechanical comminution that is, further sorting and bringing the items into appropriate sizes, e.g., by shredding, sieving or separation by rates of density, i.e. by air, a liquid or magnetically. Suitable separation methods may be supported by spectroscopic analysis such as for example IR spectroscopy. Optionally, these fragments may then undergo processes to eliminate impurities, e.g. paper labels.

Depending on the composition of the polyurethane foam it may be subjected to extraction to remove soluble additives as flame retardants, surfactants or catalysts to remain the pure polymeric polyurethane material prior to step (a).

The properties of the foams used as starting material in the process according to the present invention may vary in broad ranges. Preferably, the elastic polyurethane is thermoplastic and thermally processable.

Generally, polyurethane foams are produced by a reaction between a polyisocyanate component and a polyol component. The properties of a polyurethane foam are influenced by the types of polyisocyanate and polyol components used.

The polyurethane foams can be comminuted by conventional methods such as for example disclosed in “Recycling von Polyurethan-Kunststoffen”, W. Raßhofer, Hüthig (Heidelberg), 1994, for example by shredding, e.g. in a rotation mill or rotary mill at room temperature, to a particle size of ordinarily less than 100 mm, or even less than 20 mm, or ground, e.g. by known cold grinding processes. It is also possible that a particle size of less than 5 mm is selected, for example a particle size in the range of 0.01 mm to 5 mm, and preferably in the range of 0.01 mm to 1 mm.

According to a further embodiment, the present invention also is directed to the process as disclosed above, wherein the composition comprising a polyurethane foam is subjected to a mechanical treatment prior to step (a), selected from the group consisting of milling, beating, shredding, tearing and mixtures of two or more of these treatments.

According to the present invention, according to step (b) the composition is heated to a temperature in the range of from 150 to 220° C., preferably in a range of from 150° C. to 200° C., more preferable in a range of from 150 to 170° C. Heating may for example be conducted for a duration from 1 to 120 minutes, preferably from 10 to 90 minutes or particularly preferable from 30 to 60 minutes. Suitable techniques are in principle known to the person skilled in the art and include for example heating the composition in an oven. Step (b) may be conducted continuously or also batchwise according to the present invention.

According to step (c), a solvent mixture (SM) is used which comprises at least one alcohol and at least one compound (A1) selected from the group consisting of cyclic amides. It has been found that it is possible to dissolve the elastic polyurethane in the solvent mixture after heating the composition according to step (b). According to the present invention, typically at least 50% by weight of the elastic polyurethane present in the composition are dissolved, for example at least 60% by weight, preferably at least 70% by weight and particularly preferable up to 100% by weight of the elastic polyurethane are dissolved in the solvent mixture (SM).

Step (c) is carried out at a temperature below the boiling point of the alcohol uses, for example at a temperature in the range of from 20 to 50° C., preferably in the range of from 15 to 40° C., more preferable at a temperature in the range of from 20 to 30° C.

Compound (A1) is selected from cyclic amides. In principle, any cyclic amide can be used according to the present invention, as long as a solvent mixture (SM) with an alcohol can be formed.

The cyclic amide is preferably selected from the group consisting of lactams, for example caprolactam and/or valerolactam, at least one cyclic urea or mixtures thereof, particularly preferably caprolactam.

Suitable cyclic amides are for example also compounds containing at least one cyclic urea of the general formula (I):

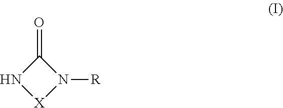

wherein —X— is a 1 to 6-membered, preferably 2 to 4-membered and particularly preferably 3-membered radical which may be substituted. This gives rise to a cyclic urea structure according to formula (I), the ring of which, including the urea structure —NH—C(O)—NR—, has 4 to 9 members, in particular 6 members. Preferably, the members of the X radical are selected from the group consisting of —NR¹—, —O—, —CR²R³—, —N═ and —CR⁴═. In the case of the —CR⁴═ or —N═ radical, the neighboring member also consists of a —CR⁴═ or —N═ member, so that the double bond can form between the two members. The radicals R¹ to R⁴ are each independently hydrogen, an alkyl radical, preferably ethyl or methyl, or halogen, for example a fluoride radical or a chloride radical. In a very particularly preferred embodiment, X is —(CH₂)₃—. The radical R according to formula (I) represents a substituted or unsubstituted alkyl or heteroalkyl group, a substituted or unsubstituted aryl group or a substituted or unsubstituted alkyl-aryl or heteroalkyl-aryl group. Examples of possible substituents are halogen groups, alkyl groups, hydroxyl groups or amine groups. In a preferred embodiment of the invention, R contains at least one isocyanate-reactive hydrogen atom, for example an —OH or —NH₂ group. Preferably R is methyl, ethyl, propyl, pentyl, hexyl, one or more alkylene oxide moieties, for example oxyethylene, oxypropylene or mixtures of oxyethylene and oxypropylene, and phenyl, or phenyl ether. R is particularly preferably—methyl, ethyl, oxyethylene, oxypropylene or phenyl methoxy ester, very particularly preferably methyl. Bridged cyclic urea structures can likewise be used as cyclic urea compounds, with two cyclic urea structures being bridged via the radical R.

R is very particularly preferably a linear, unsubstituted hydrocarbon radical selected from methyl, ethyl, propyl, pentyl and hexyl, in particular R is a methyl radical.

Preferably, compound (A1) is a lactam. According to a further embodiment, the present invention also is directed to the process as disclosed above, wherein compound (A1) is a lactam.

Particularly suitable examples include lactams of omega-amino carboxylic acids, such as 3-amino propionic acid, 4-amino butyric acid, 5-amino valeric acid, 6-amino caproic acid or 10-amino capric acid; N-substituted azalactams, such as 1-N-methyl-hexahydro-1,4-diazepinone-(3); 1-N-butyl-hexahydro-1,4-diazepinone-(3); 1-N-alpha-pyridyl-hexahydro-1,4-diazepinone-(3), and the like.

Particularly suitable are for example 2-pyrrolidone, 2-piperidone, epsilon-caprolactam and laurolactam. According to a further embodiment, the present invention also is directed to the process as disclosed above, wherein compound (A1) is selected from the group consisting of 2-pyrrolidone, 2-piperidone, epsilon-caprolactam and laurolactam.

Suitable alcohols for solvent mixture (SM) are in particular monools and diols with 1 to 12 carbon atoms, in particular 1 to 6 carbon atoms, for example methanol, ethanol, propanol, butanol, ethandiol, propandiol, or butandiol. According to a further embodiment, the present invention also is directed to the process as disclosed above, wherein the alcohol is selected from the group consisting of methanol, ethanol and propanol.

According to the present invention, solvent mixture (SM) might also contain two or more lactams or two or more alcohols. The mixing ratio of the lactams and alcohols might vary in broad ranges as long as a homogeneous solution is obtained. Preferably, the molar ratio of the at least one lactam and the at least one alcohol in the solvent mixture (SM) is in the range of from 2:1 to 1:2, in particular in the range of from 1.5:1 to 1:1.5, more preferable in the range of from 1.2:1 to 1:1.2.

According to a further embodiment, the present invention also is directed to the process as disclosed above, wherein the molar ratio of the at least one lactam and the at least one alcohol in the solvent mixture (SM) is in the range of from 2:1 to 1:2.

The solvent mixture (SM) is used in an amount suitable to dissolve the elastic polyurethane in step (c) of the process according to the present invention. Suitable amounts depend on the solvent mixture used and the polyurethane. Typically, the weight ratio of the composition comprising the polyurethane foam and the solvent mixture (SM) is in the range of 1:2 to 1:20, preferably in the range of from 1:2 to 1:10.

According to a further embodiment, the present invention also is directed to the process as disclosed above, wherein the weight ratio of the composition comprising the polyurethane foam and the solvent mixture (SM) is in the range of 1:2 to 1:20.

According to step (c), a solution (S1), which is enriched in dissolved polyurethane is obtained. In case the composition is not completely dissolved and residues remain which do not dissolve in the solvent mixture (SM) used, the solution (S1) preferably is separated from the non soluble residues by suitable separation steps.

According to a further embodiment, the present invention also is directed to the process as disclosed above, wherein the process further comprises step (d)
(d) separating the solution (S1), which is enriched in dissolved polyurethane and the residue of the composition comprising a polyurethane foam obtained in (c).

The separation may be carried out in customary devices in a fashion known to the person skilled in the art. Suitable methods are in particular physical separation methods such as filtration, decanting or centrifuging, in particular filtration. According to a further embodiment, the present invention therefore is also directed to the process as disclosed above, wherein the separation according to step (d) is conducted by a physical separation method.

The separation, in particular the filtration may be carried out discontinuously in batch mode or continuously, semi-continuously.

After the separation, suitable washing steps may be applied according to the process of the present invention.

According to step (d), the solution (S1) is obtained. The polyurethane may be recovered from solution (S1) using suitable methods. It is for example possible to remove the solvent to obtain the polyurethane as such. According to the present invention it is also possible to add suitable compounds to solution (S1) which result in the precipitation of the polyurethane. It is for example possible to add water to the solution in a suitable amount to result in the precipitation of the polyurethane which may then be isolated using a filtration step.

According to a further embodiment, the present invention also is directed to the process as disclosed above, wherein the process further comprises step (e)
(e) removal of the solvent mixture form the solution (S1) which is enriched in dissolved polyurethane to obtain the polyurethane.

According to the present invention, it is also possible that one or more components of the solvent mixture are removed or that the solvent mixture is only partially removed. In particular, the alcohol present in the solvent mixture can for example be easily removed at ambient temperature under reduced pressure.

According to an alternative embodiment, the present invention also is directed to the process as disclosed above, wherein the process further comprises step (e*)
(e*) addition of water to the solution (S1) to obtain the polyurethane.

According to the present invention, step (e*) can be carried out after step (d). According to a further embodiment of the present invention, one or more components of the solvent mixture are removed prior to step (e*) or the solvent mixture is partially removed prior to step (e*).

The process of the present invention also may comprise further steps such as washing steps to remove traces of the remaining solvents or drying steps.

According to the present invention, it is also possible to use the solution (S1) obtained in step (d) as such for the preparation of a shaped article. Processes for preparing a shaped article from a solution containing a dissolved polyurethane are in principle known to the person skilled in the art and include for example processes for preparing membranes or processes for syn-thetic leather production, or processes for preparing fibers from solution such as for example spinning processes. Suitable processes are for example disclosed in “New materials permeable to water vapor”, H. Träubel, Springer-Verlag, 1999, chapter 8.

The process according to the present invention comprises steps (a), and (b), (c) and optionally (d) and/or (e)/(e*) but may also comprise further steps. The process may for example comprise further purification steps or heat treatments. According to a further embodiment, the present invention is also directed to the process as disclosed above, wherein the process comprises further purification steps.

Suitable treatment steps are in principle known to the person skilled in the art. Suitable treatment and/or purification steps may be carried out between steps (a) and (b), or between steps (b) and (c) or between steps (c) and (d).

The process according to the present invention is also applicable to polyurethane foam waste. Herein, the term “polyurethane foam waste” includes end-of-life polyurethane foams and production rejects of PU foams. In this context, the term “spent polyurethane foam” denotes an item produced from a polyurethane foam at a time when it has already been used for the purpose for which it was manufactured. “Production rejects of polyurethane foams” denotes polyurethane foam waste occurring in production processes of PU foams.

Generally, polyurethane foams are produced by a reaction between a polyisocyanate component and a polyol component. Particularly suitable foams are for example foams which can be thermoplastically processed such as for example foams as disclosed in WO 2019/122122 A1. Further materials, such as flame retardants, polymerization catalysts, fillers, pigments and surfactants may be added in the production process of the polymers.

Organic polyisocyanates that can be used in the preparation of polyurethanes are any of the known organic di- and polyisocyanates, preferably aromatic polyfunctional isocyanates. Preferably, an isocyanate component having a functionality in the range of from 1.9 to 2.2 is used according to the present invention, in particular in the range of from 1.95 to 2.1, more preferable in the range of from 1.95 to 2.05, most preferable in the range of from 1.96 to 2.03.

Individual examples which may be mentioned are tolylene 2,4 and 2,6-diisocyanate (TDI) and the corresponding isomer mixtures, diphenylmethane 4,4′,2,4′ and 2,2′ diisocyanate (MDI) and the corresponding isomer mixtures, mixtures composed of diphenylmethane 4,4′- and 2,4′-diisocyanates, polyphenyl polymethylene polyisocyanates, mixtures composed of diphenylmethane 4,4′-, 2,4′- and 2,2′-diisocyanates The organic di- and polyisocyanates may be used indi-vidually or in the form of mixtures. If isocyanates having a higher functionality are used in these mixtures, the functionality of the mixture preferably is not more than 2.2. In addition, the proportion of isocyanates having a higher functionality must not be more than 10% by weight, preferably not more than 5% by weight, based on the overall mixture of isocyanates.

Compounds which may be used for the preparation of polyurethanes which have at least two hydrogen atoms reactive toward isocyanate groups are those which bear at least two reactive groups selected from OH groups, SH groups, NH groups, NH2 groups, and acidic CH groups.

Preferably polyols are used and in particular polyether alcohols and/or polyester alcohols whose OH numbers are in the range from 25 to 800 mg KOH/g. According to the present invention, preferably a polyol component having a functionality in the range of from 1.7 to 2.2 is used, in particular in the range of from 1.7 to 2.1, more preferable in the range of from 1.7 to 2.05, most preferable in the range of from 1.7 to 2.03. It is also possible here to use mixtures of polyols. If polyols having a higher functionality are used in these polyol mixtures, the functionality of the mixture preferably is not more than 2.2. In addition, the proportion of polyols having a higher functionality must not be more than 10% by weight, preferably not more than 5% by weight, based on the overall mixture of polyols.

The polyester alcohols used are mostly prepared via condensation of polyhydric alcohols, preferably diols, having from 2 to 12 carbon atoms, preferably from 2 to 6 carbon atoms, with poly-basic carboxylic acids having from 2 to 12 carbon atoms, e.g. succinic acid, glutaric acid, adipic acid, suberic acid, azelaic acid, sebacic acid, decanedicarboxylic acid, maleic acid, fumaric acid, or preferably phthalic acid, isophthalic acid, terephthalic acid, or the isomeric naphtha-lenedicarboxylic acids.

Polyether polyols particularly used are those prepared by known processes, e.g. via anionic polymerization of alkylene oxides onto H-functional starter substances in the presence of catalysts, preferably alkali metal hydroxides or double-metal-cyanide catalysts (DMC catalysts). Alkylene oxides used are mostly ethylene oxide or propylene oxide, or else tetrahydrofuran, vari-ous butylene oxides, or styrene oxide, and preferably pure propylene 1,2-oxide. The alkylene oxides can be used alone, in alternating succession, or in the form of a mixture. Starter substances particularly used are compounds having at least 2, preferably from 2 to 8, hydroxy groups or having at least two primary amino groups in the molecule. Starter substances used and having at least 2, preferably from 2 to 8, hydroxy groups in the molecule are preferably tri-methylolpropane, glycerol, pentaerythritol, sugar compounds, such as glucose, sorbitol, mannitol, and sucrose, polyhydric phenols, resols, e.g. oligomeric condensates composed of phenol and formaldehyde, and Mannich condensates composed of phenols, of formaldehyde, and of dialkanolamines, and also melamine. Starter substances used and having at least two primary amino groups in the molecule are preferably aromatic di and/or polyamines, such as phe-nylenediamines, 2,3-, 2,4-, 3,4, and 2,6 tolylenediamine, and 4,4′-, 2,4′-, and 2,2′ diaminodiphe-nyl, methane, and also aliphatic di and polyamines, such as ethylenediamine. The preferred functionality of the polyether polyols is from 2 to 8 and their preferred hydroxy numbers are from 25 to 800 mg KOH/g, in particular from 150 to 570 mg KOH/g.

Other compounds having at least two hydrogen atoms reactive toward isocyanate are crosslinking agents and chain extenders which may be used concomitantly, if appropriate. Chain extenders preferably used are alkanolamines and in particular diols with molecular weights below 400, preferably from 60 to 300. The amount advantageously used of chain extenders, crosslinking agents, or mixtures of these is from 1 to 20% by weight, preferably from 2 to 5% by weight, based on the polyol component.

Common polyols used in huge quantities are, e.g., polyester polyols, low molecular weight polyols such as ethylene glycol or propylene glycol, or high molecular weight polyether polyols based on glycerol, ethylene glycol, polypropylene glycol, polytetramethylene glycol, and polyesterpolyols.

In addition, one or more blowing agents may also be present in the production of the elastic polyurethane used. Blowing agents used may be chemically active blowing agents and/or physi-cally active compounds. Chemical blowing agents are understood to mean compounds that form gaseous products by reaction with isocyanate, for example water and carboxylic acids or carboxylic acid derivatives, for example hydrogencitrates, hydrogencarbonates or azodicarbon-amides, such as Celegoene®, Tracel®, Hydrocerol® or mixtures thereof, water being a preferred blowing agent.

Physical blowing agents are understood to mean compounds that are dissolved or emulsified in the feedstocks for polyurethane production and evaporate under the conditions of polyurethane formation. These are, for example, hydrocarbons, halogenated hydrocarbons, and other compounds, for example perfluorinated alkanes, such as perfluorohexane, hydrochlorofluorocar-bons, and ethers, esters, ketones and/or acetals, for example (cyclo)aliphatic hydrocarbons having 4 to 8 carbon atoms, hydrofluoroolefins (HFOs), or gases, such as carbon dioxide, or mixtures thereof. In a preferred embodiment, the blowing agent used is a mixture of these blowing agents comprising water, more preferably exclusively water.

In a preferred embodiment, the water content is from 0.1% to 6% by weight, preferably 1% to 5% by weight, more preferably 2.5% to 4% by weight, based on the total weight of the elastic polyurethane foam.

Preferably, the foams are based on an isocyanate component having a functionality in the range of from 1.9 to 2.2 and a polyol component having a functionality in the range of from 1.7 to 2.2.

According to a further aspect, the present invention is also directed to the polyurethane obtained or obtainable according to a process as disclosed above. Preferably, the polyurethane obtained is thermoplastic and preferably can be processed thermally, for example by extrusion or injection molding.

The polyurethane obtained according to the process of the present invention may be used without further modifications for any suitable application. It is also possible to use the polyurethane in a mixture with further compounds, in particular further polyurethanes or additives for the preparation of shaped articles.

In principle, processes for preparing shaped article from polyurethanes are known to the person skilled in the art.

According to a further aspect, the present invention is also directed to the use of the polyurethane according to the present invention or a polyurethane obtained or obtainable according to the process of the present invention for the preparation of a shaped article.

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed im-plicitly even if this combination is not mentioned explicitly.

Illustrative embodiments of the present invention are listed below, but these do not restrict the present invention. In particular, the present invention also encompasses those embodiments which result from the dependency references and hence combinations specified hereinafter.
1. A process for recovering a elastic polyurethane from a composition comprising an elastic polyurethane foam comprising the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane.
2. The process according to embodiment 1, wherein the polyurethane foam is a flexible polyurethane foam.
3. The process according to any one of embodiments 1 or 2, wherein compound (A1) is a lactam.
4. The process according to any one of embodiments 1 to 3, wherein compound (A1) is selected from the group consisting of 2-pyrrolidone, 2-piperidone, epsilon-caprolactam and laurolactam.
5. The process according to any one of embodiments 1 to 4, wherein the alcohol is selected from the group consisting of methanol, ethanol and propanol.
6. The process according to any one of embodiments 1 to 5, wherein compound (A1) is a lactam and the alcohol is selected from the group consisting of methanol, ethanol and propanol.
7. The process according to any one of embodiments 1 to 6, wherein compound (A1) is selected from the group consisting of 2-pyrrolidone, 2-piperidone, epsilon-caprolactam and laurolactam and the alcohol is selected from the group consisting of methanol, ethanol and propanol.
8. The process according to any one of embodiments 1 to 7, wherein compound (A1) is epsi-lon-caprolactam and the alcohol is selected from the group consisting of methanol, ethanol and propanol, preferably methanol.
9. The process according to any one of embodiments 1 to 8, wherein the molar ratio of the at least one lactam and the at least one alcohol in the solvent mixture (SM) is in the range of from 2:1 to 1:2.
10. The process according to any one of embodiments 1 to 9, wherein the weight ratio of the composition comprising the polyurethane foam and the solvent mixture (SM) is in the range of 1:2 to 1:20.
11. The process according to any one of embodiments 1 or 10, wherein the process further comprises step (d)
   (d) separating the solution (S1), which is enriched in dissolved polyurethane and the residue of the composition comprising a polyurethane foam obtained in (c).
12. A process for recovering a elastic polyurethane from a composition comprising an elastic polyurethane foam comprising the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c).
13. The process according to embodiment 11 or 12, wherein the separation according to step (d) is conducted by a physical separation method.
14. The process according to any one of embodiments 1 to 13, wherein the composition comprising a polyurethane foam is subjected to a mechanical treatment prior to step (a), selected from the group consisting of milling, beating, shredding, tearing and mixtures of two or more of these treatments.
15. The process according to any one of embodiments 1 to 14, wherein the process further comprises step (e)
   (e) removal of the solvent mixture form the solution (S1) which is enriched in dissolved polyurethane to obtain the polyurethane.
16. A process for recovering a elastic polyurethane from a composition comprising an elastic polyurethane foam comprising the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c),
   (e) removal of the solvent mixture form the solution (S1) which is enriched in dissolved polyurethane to obtain the polyurethane.
17. The process according to any one of embodiments 1 to 14, wherein the process further comprises step (e*)
   (e*) addition of water to the solution (S1) to obtain the polyurethane.
18. A process for recovering a elastic polyurethane from a composition comprising an elastic polyurethane foam comprising the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c),
   (e*) addition of water to the solution (S1) to obtain the polyurethane.
19. Polyurethane obtained or obtainable according to a process according to any one of embodiments 1 to 18.
20. Polyurethane obtained or obtainable according to a process for recovering a elastic polyurethane from a composition comprising an elastic polyurethane foam comprising the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane.
21. The polyurethane according to embodiment 20, wherein the polyurethane foam is a flexible polyurethane foam.
22. The polyurethane according to any one of embodiments 20 or 21, wherein compound (A1) is a lactam.
23. The polyurethane according to any one of embodiments 20 to 22, wherein compound (A1) is selected from the group consisting of 2-pyrrolidone, 2-piperidone, epsilon-caprolactam and laurolactam.
24. The polyurethane according to any one of embodiments 20 to 23, wherein the alcohol is selected from the group consisting of methanol, ethanol and propanol.
25. The polyurethane according to any one of embodiments 20 to 24, wherein compound (A1) is a lactam and the alcohol is selected from the group consisting of methanol, ethanol and propanol.
26. The polyurethane according to any one of embodiments 20 to 25, wherein compound (A1) is selected from the group consisting of 2-pyrrolidone, 2-piperidone, epsilon-caprolactam and laurolactam and the alcohol is selected from the group consisting of methanol, ethanol and propanol.
27. The polyurethane according to any one of embodiments 20 to 26, wherein compound (A1) is epsilon-caprolactam and the alcohol is selected from the group consisting of methanol, ethanol and propanol, preferably methanol.
28. The polyurethane according to any one of embodiments 20 to 27, wherein the molar ratio of the at least one lactam and the at least one alcohol in the solvent mixture (SM) is in the range of from 2:1 to 1:2.
29. The polyurethane according to any one of embodiments 20 to 28, wherein the weight ratio of the composition comprising the polyurethane foam and the solvent mixture (SM) is in the range of 1:2 to 1:20.
30. The polyurethane according to any one of embodiments 20 or 29, wherein the process further comprises step (d)
   (d) separating the solution (S1), which is enriched in dissolved polyurethane and the residue of the composition comprising a polyurethane foam obtained in (c).
31. The polyurethane according to any one of embodiments 20 to 30, wherein the process comprises the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c).
32. The process according to embodiment 30 or 31, wherein the separation according to step (d) is conducted by a physical separation method.
33. The process according to any one of embodiments 20 to 32, wherein the composition comprising a polyurethane foam is subjected to a mechanical treatment prior to step (a), selected from the group consisting of milling, beating, shredding, tearing and mixtures of two or more of these treatments.
34. The process according to any one of embodiments 20 to 33, wherein the process further comprises step (e)
   (e) removal of the solvent mixture form the solution (S1) which is enriched in dissolved polyurethane to obtain the polyurethane.
35. The polyurethane according to any one of embodiments 20 or 34, wherein the process comprises the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c),
   (e) removal of the solvent mixture form the solution (S1) which is enriched in dissolved polyurethane to obtain the polyurethane.
36. The process according to any one of embodiments 20 to 35, wherein the process further comprises step (e*) (e*) addition of water to the solution (S1) to obtain the polyurethane.
37. The polyurethane according to any one of embodiments 20 or 36, wherein the process comprises the steps of
   (a) providing a composition comprising a polyurethane foam;
   (b) heating the composition comprising a polyurethane foam to a temperature in the range of from 140° C. to 220° C.;
   (c) bringing the composition comprising the polyurethane foam into contact with a solvent mixture (SM) comprising at least one alcohol and least one compound (A1) selected from the group cyclic amides at a temperature below the boiling point of the alcohol to obtain a solution (S1) which is enriched in dissolved polyurethane,
   (d) separating the solution (S1), which is enriched in dissolved polyurethane and the residue of the composition comprising a polyurethane foam obtained in (c),
   (e*) addition of water to the solution (S1) to obtain the polyurethane.
38. Use of the polyurethane according to any one of embodiments 19 to 37 or a polyurethane obtained or obtainable according to the process of any one of embodiments 1 to 18 for the preparation of a shaped article.

The invention is further described by examples. The examples relate to practical and in some cases preferred embodiments of the invention that do not limit the scope of the invention.

### EXAMPLES

### 1. Materials Used

| | |
|---|---|
| polyol 1 | Polyetherol based on propyleneglycol and propylene oxide |
| | (MW: 1970 g/mol) |
| polyol 2 | Polyetherol based on propyleneglycol and propylene oxide |
| | with EO endcap (18.5%), (MW: 3410 g/mol), functionality |
| | 1.76 |
| catalyst 1 | Sn^{II}-isooctoat (97%) |
| catalyst 2 | Triethylendiamin (33%), Dipropylenglykol |
| stabilizer | silicon stabilizer |
| isocyanate 1 | 2,4-TDI (80%) and 2,6-TDI (20%) |
| isocyanate 2 | 2,4′-MDI (48%), 4,4′-MDI (49%), 2,2′-MDI (2.4%) |
| isocyanate 2 | Carbodiimid modified 4,4′-MDI (76%), 4,4′-MDI (24%) |

### 2. Example 1

2.1 A foam was prepared using the A component summarized in table 1 and isocyanate 1 as B component with an index of 90 to 115.

| | | |
|---|---|---|
| A component | Polyol 1 | 95.5 |
| | Stabilizer | 1.0 |
| | Catalyst 1 | 0.3 |
| | Catalyst 2 | 0.2 |
| | water | 3.1 |

A first sample was prepared in a beaker (0.56 L). The foam was completely soluble in a mixture of caprolactam/MeOH (1:1.2 mol) using the solvent mixture in a ratio of 1:10.

Further samples with larger blocks were prepared (64 L and 2600 L). The respective samples were only partially soluble and the core area of the block foams was not soluble in the solvent mixture.
2.2 Samples from the block foams were subjected to a tempering step at a temperature of above 150° C. for a duration of 10 minutes to 1 hour and an improvement of the solubility could be observed.

### 3. Example 2

MDI-based linear foams have also been developed. The tests were all carried out as a cup test (0.65 L).

The A component consisted of polyol 2, an amine catalyst, and tap water. The B component was based on the a mixture of isocyanate 2 and isocyanate 3. The proportion of isocyanate 3 in the B component was successively increased to increase overall functionality of the B component. With a composition of 87 parts isocyanate 2 and 13 parts isocyanate 3 in the B component, the foams were all directly soluble. With 15, 18 and 22 parts isocyanate 3 in the B component, the foams were no longer directly soluble. Therefore, the foams were tempered at 150° C. for 1 h and subsequently were soluble at room temperature. With more than 27 parts of isocyanate 3 in the B component, the foams were no longer soluble even after a tempering step. The results are summarized in table 2.

| | Sample | Sample | Sample | Sample | Sample | Sample | Sample | Sample | Sample |
|---|---|---|---|---|---|---|---|---|---|
| | A | B | C | D | E | F | G | H | I |
| Functionality of A | 1.965 | 1.965 | 1.965 | 1.965 | 1.965 | 1.965 | 1.965 | 1.965 | 1.965 |
| component | | | | | | | | | |
| Functionality of B | 2.00 | 2.008 | 2.016 | 2.018 | 2.020 | 2.021 | 2.025 | 2.030 | 2.037 |
| component | | | | | | | | | |
| Index | 85 | 85 | 85 | 85 | 85 | 85 | 85 | 85 | 85 |
| Solubility without | + | + | + | + | + | + | − | − | − |
| heat treatment | | | | | | | | | |
| Solubility after | + | + | + | + | + | + | + | + | + |
| heat treatment | | | | | | | | | |

### LITERATURE CITED

U.S. Pat. No. 4,115,298A
U.S. Pat. No. 4,160,749A
“Recycling von Polyurethan-Kunststoffen”, W. Raßhofer, Hüthig (Heidelberg), 1994
“New materials permeable to water vapor”, H. Träubel, Springer-Verlag, 1999, chapter 8
K. Wagner, Angew. Makromol. Chem. 1974, 37, 59-88

1. A process for recovering an elastic polyurethane from a composition comprising an elastic polyurethane foam comprising:
(a) providing a composition comprising a polyurethane foam;
(b) heating the composition comprising a polyurethane foam to a temperature of 140° C. to 220° C.; and
(c) bringing the composition comprising the polyurethane foam into contact with a solvent mixture (SM) comprising at least one alcohol and at least one cyclic amide (A1) at a temperature below a boiling point of the alcohol to obtain a solution (S1) which is enriched in dissolved polyurethane.

2. The process according to claim 1, wherein the polyurethane foam is a flexible polyurethane foam.

3. The process according to claim 1, wherein the cyclic amide (A1) is a lactam.

4. The process according to claim 1, wherein the cyclic amide (A1) is selected from the group consisting of 2-pyrrolidone, 2-piperidone, epsilon-caprolactam, and laurolactam.

5. The process according to claim 1, wherein the alcohol is selected from the group consisting of methanol, ethanol, and propanol.

6. The process according to claim 1, wherein a molar ratio of the cyclic amide and the alcohol in the solvent mixture (SM) is 2:1 to 1:2.

7. The process according to claim 1, wherein a weight ratio of the composition comprising the polyurethane foam and the solvent mixture (SM) is 1:2 to 1:20.

8. The process according to claim 1, wherein the process further comprises:
(d) separating the solution (S1) and a residue of the composition comprising a polyurethane foam obtained in (c).

9. The process according to claim 8, wherein (d) is conducted by a physical separation method.

10. The process according to claim 1, wherein the composition comprising a polyurethane foam is subjected to a mechanical treatment prior to (a) comprising at least one selected from the group consisting of milling, beating, shredding, and tearing.

11. The process according to claim 1, wherein the process further comprises:
(e) removing the solvent mixture from the solution (S1) which is enriched in dissolved polyurethane to obtain the polyurethane.

12. The process according to claim 1, wherein the process further comprises:
(e*) adding water to the solution (S1) to obtain the polyurethane.

13. A polyurethane obtained by the process according to claim 1.

14. A process for preparing a shaped article, comprising processing the polyurethane according to claim 13.
